(19) United States
(12) Patent Application Publication
(10) Pub. No.: US 2010/0025262 A1
(43) Pub. Date: Feb. 4, 2010

(54) Method for removing a protective coating from a component

(76) Inventors: Rene Jabado, Berlin (DE); Jens Dahl Jensen, Berlin (DE); Ursus Krüger, Berlin (DE); Daniel Körtvelyessy, Berlin (DE); Volkmar Lüthen, Berlin (DE); Ralph Reiche, Berlin (DE); Michael Rindler, Schoneiche (DE); Raymond Ullrich, Schonwalde (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/308,731

(22) PCT Filed: Jun. 19, 2007
(86) PCT No.: PCT/EP2007/056093

§ 371 Date: Aug. 27, 2009

(30) Foreign Application Priority Data
Jun. 27, 2006 (DE) 10 2006 030 364.4

(51) Int. Cl. B08B 3/12; C25F 5/00; C25B 9/04

(52) U.S. Cl. 205/771; 134/1; 134/115 R; 204/230.2

(57) ABSTRACT

The invention relates inter alia to a method for removing a protective coating from a component, especially a turbine blade. According to the invention, the protective coating is removed, using mechanical shock waves having a shock wave repetition rate below 20 kHz.

### CROSS REFERENCE TO RELATED APPLICATIONS

This application is the U.S. National Stage of International Application No. PCT/EP2007/056093, filed Jun. 19, 2007 and claims the benefit thereof. The International Application claims the benefits of German application No. 10 2006 030 364.4 filed Jun. 27, 2006, both of the applications are incorporated by reference herein in their entirety.

### FIELD OF INVENTION

The invention relates to a method for removing a protective coating from a component, especially a turbine blade.

### BACKGROUND OF THE INVENTION

The practice is known, during repairs and maintenance work on gas turbines, of having to completely remove harmful protective coatings which are applied to the rotating and stationary blades of the gas turbines, so as to ensure that no problems arise when applying a new coating. In this regard a known method is to use chemical coating removal processes in which the protective coatings are etched away.

In chemical coating removal processes the process time is relatively long and the cleaning quality is at times not sufficiently thorough, so that a subsequent recoating is rendered difficult.

### SUMMARY OF INVENTION

The underlying object of the invention is accordingly to specify a method for removing a protective coating from a component which can be executed in a very short time and in which very good cleaning results are achieved.

In accordance with the invention this object is achieved by a method with the features as claimed in the claims. Advantageous embodiments of the inventive method are specified in subclaims.

The invention accordingly makes provision for the protective coating to be removed from the component using mechanical shock waves with a shock wave repetition frequency below 20 kHz.

A significant advantage of the method in accordance with the invention is to be seen in a very even cleaning effect being able to be achieved as a result of the inventive use of shock waves. In practice the good cleaning results are attributable to the fact that relatively high shock amplitudes occur with shock waves which bring about a correspondingly great cleaning effect. Shock waves are characterized by an extremely high pressure amplitude with an increase in pressure in the nanosecond range as well as by downstream oscillations with lower amplitudes in the microsecond range (2 kHz to 10 MHz=“tensile components”). The peak pressures occurring typically lie in the range of 10 to 500 MPa. The inventively provided shock waves thus differ quite significantly from for example ultrasound waves, which exhibit frequencies above 20 kHz and are known to be used in a frequency range between 30 and 400 kHz for cleaning purposes. As a result of the way in which they are generated, ultrasound waves namely have a periodic frequency response with only a small amplitude by comparison with shock waves. The primary force effect of ultrasound waves thus occurs at places of different material thickness through cavitation effects; By contrast, in the way provided for in the invention in which shock waves are used with a shock wave repetition frequency below 20 kHz cleaning is essentially undertaken by direct force impulse transmission to the border surfaces as a result of the very high pressure change in the nanosecond range, which improves the cleaning effect.

A further significant advantage of the inventive method is to be seen in the fact that the protective layer is removed very quickly, since by the application of the shock waves or impact waves during the coating removal process the protective coating already damaged for example by chemical effects is almost blown off by the high force effect of the shock waves, which leads to a very high process speed overall.

As already mentioned, the method can be used for the removal of protective coatings which are applied to turbine blades. As well as the old protective coating this also allows contaminants incorporated by the operation of the turbine to be removed. With turbine blades these contaminants typically consist of mixtures of calcium, magnesium, silicon, nickel and iron as well as carbonate and oxide compounds; Multi element spinel compounds can also occur. These contaminants typically combine and form the especially damaging calcium-magnesium-aluminum-silicon oxide system (“OMAS”); this too can be removed comparatively easily with the method described.

Further contaminants, such as thermally grown oxide (“TGO”), Cr₂O₃ and CrₓCo_{y}O spinels as well as the corresponding carbide compounds depending on the basic material of the component can be very easily removed with the described method using the shock waves.

The shock waves can for example be generated electrohydraulically electromagnetically, piezoelectrically or pneumatic-ballistically.

In respect of the fastest possible removal of the protective layer it is seen as advantageous for the component to be inserted into a cleaning bath which chemically attacks or removes the protective coating and for mechanical shock waves to be additionally directed onto the component during the chemical attack on the protective coating. In this embodiment of the method a combination of two cleaning effects is thus used, namely the cleaning effect of the chemical bath as well as the cleaning effect of the shock waves.

An especially fast removal of the protective coating can be achieved if the chemical bath is formed by an electrolyte to which an electrical voltage is applied and in which an electric current is produced. Preferably a positive potential will be applied to the component to be cleaned and a negative potential to the electrolyte.

The shock waves can be created especially simply and thus advantageously by said shock waves being fed into the cleaning bath by a shock wave generation element arranged spatially separate from the outside of the component.

In respect of an especially great cleaning effect it is seen as advantageous for the shock waves to be focused on the outer side of the component; Such focusing is for example possible by a plurality of individual shock wave generator elements being arranged on a parabolic surface such that there is a directional effect of the shock waves on the component to be cleaned. These type of individual shock wave generator elements can be formed by piezo actuators for example.

Very good cleaning results can be achieved if the shock waves are directed perpendicular to the outer side of the component to be cleaned.

The shock waves can also be fed directly into the outer side of the component as surface shock waves with a shock wave generator element coupled mechanically to the outer side of the component.

If the protective coating is to be removed from a turbine blade, it is seen as advantageous for the shock waves to be directed perpendicularly onto the surface of the turbine blade. In addition the surface shock waves already mentioned can be fed directly into the blade surfaces of the turbine blades with a generator element generating surface shock waves coupled mechanically to the outer side.

### BRIEF DESCRIPTION OF THE DRAWINGS

The invention is explained in more detail below on the basis of an exemplary embodiment; the figures show the following examples

FIG. 1 a turbine blade with a protective coating that is to be removed,

FIG. 2 an arrangement for removing the protective coating from the turbine blade in accordance with FIG. 1,

FIG. 3 a further exemplary embodiment for an arrangement for removing the protective coating from the turbine blade in accordance with FIG. 1,

FIG. 4 the turbine blade in accordance with FIG. 1 with a generator element for generating surface shock waves attached to it,

FIG. 5 the turbine blade in accordance with FIG. 1 with the generator in a different position from that depicted in FIG. 4,

FIG. 6 an arrangement for creating focused shock waves and

FIG. 7 an example of the amplitude curve of shock waves over time.

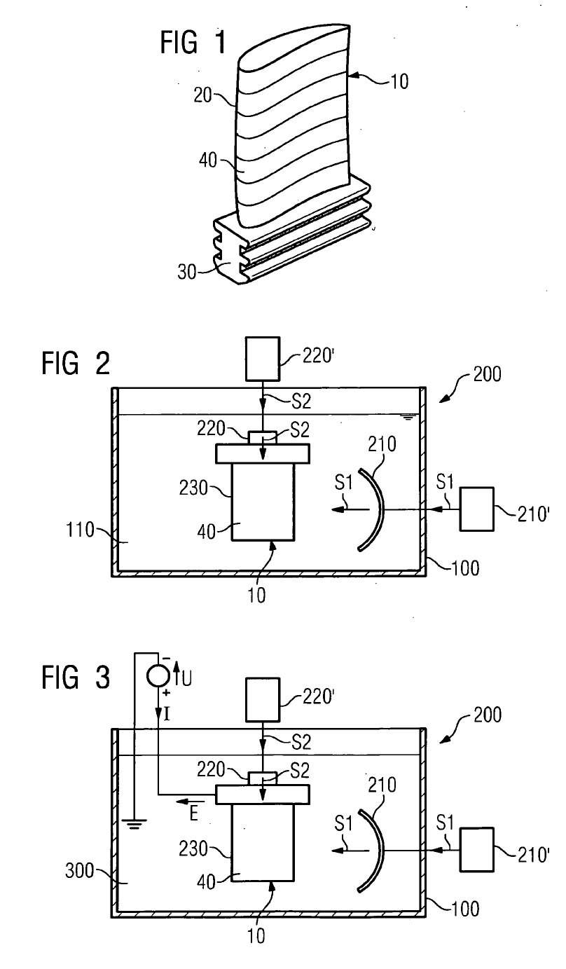

For reasons of clarity the same reference symbol is always used in FIGS. 1 to 7 for identical or comparable components.

### DETAILED DESCRIPTION OF INVENTION

FIG. 1 shows a turbine blade 10 with a vane 20 as well as a foot 30 in a three-dimensional diagram. The vane 20 of the turbine blade 10 is provided with a protective coating 40, which is damaged because of wear during the operation of the turbine blade and is to be removed to allow recoating of the turbine blade 10. The protective coating 40 can for example consist of TBC (Thermal Barrier Coating) material on basis of a columnar zirconium oxide ceramic layer or consist of MCrAlY material (metal matrix material based on chrome, aluminum and ytrium). The foot 30 of the turbine blade 10 is preferably uncoated.

FIG. 2 shows an arrangement for removing the protective coating 40 from the turbine blade 10. The arrangement features a chemical bath 100 in which there is an acid, for example 20% hydrochloric acid 110, at a temperature of for example 70° C. The turbine blade 10 is immersed in the bath 100 and thus chemically subjected to the acid 110 contained therein. The acid 110 attacks the protective coating 40 of the turbine blade 10 which removes said coating from the surface of the turbine blade after a sufficiently long period.

In order to accelerate the removal of the protective coating 40, in the arrangement in accordance with Figure a device for creating shock waves is additionally provided. The device is identified by the reference symbol 200 and has a shock wave generator element 210 as well as a generator element 220 generating surface shock waves which are activated by controllers 210′ and 220′.

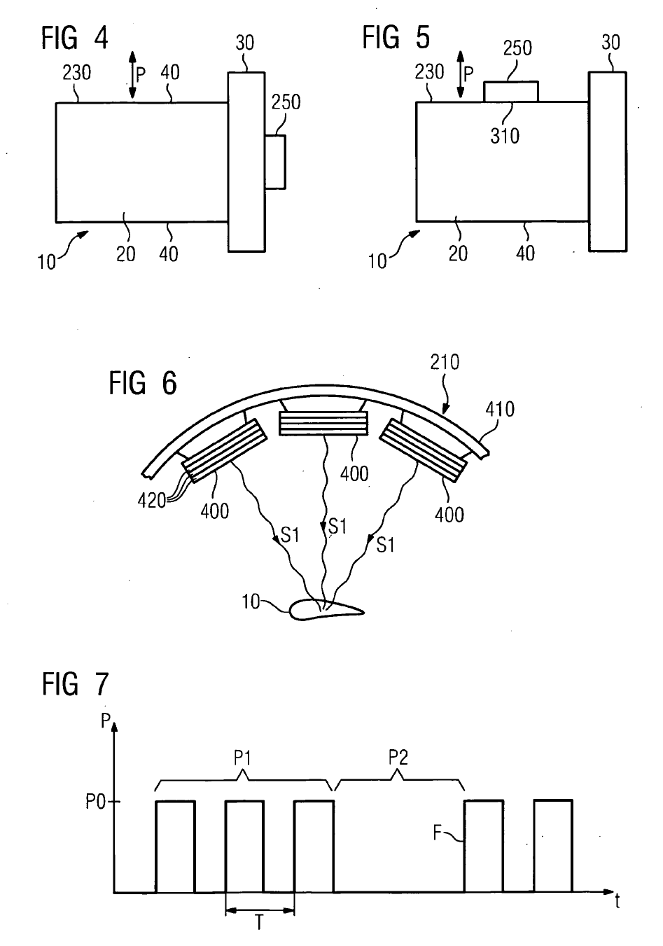

The shock wave generator element 210 creates shock waves S1, which are directed perpendicular, at least quasi perpendicular, onto the outer side or surface 230 of the turbine blade 20. The surface shock waves S2 are coupled directly into the turbine blade 10 from the generator element 220, as will be explained below in conjunction with FIGS. 4 and 5.

The additional creation of the shock waves S1 and S2 with the aid of the shock wave generator element 210 and the generator element 220 allows the removal of the protective coating 40 from the turbine blade to be greatly speeded up, since the chemical cleaning effect of the hydrochloric acid 110 is also supported by the mechanical cleaning effect of the shock waves. The shock waves preferably have a shock wave repetition frequency FS between 1 and 2000 Hz as well as peak pressures of between 10 and 500 MPa.

FIG. 3 shows a further exemplary embodiment for an arrangement for removal of the protective coating 40 of the turbine blade 10 in accordance with FIG. 1. The arrangement depicted in FIG. 3 corresponds to the arrangement shown in FIG. 2 with the difference that a chemical bath 100 with an electrolyte 300 is used. The electrolyte 300 involved can for example be 5% hydrochloric acid at a temperature of 20° C.

An electrical field E is applied to the electrolyte 300. Preferably the electrical field is created by a positive potential being applied to the turbine blade from which the protective coating 40 is to be removed and a negative potential applied to the electrolyte 300.

In the exemplary embodiment depicted in FIG. 4 a total of three cleaning effects are used, namely the cleaning effect of the 5% hydrochloric acid, the cleaning effect of the shock waves and also the cleaning effect through the current flow, which can amount to around 100 A for example and is generated in the electrolyte 300 by a voltage U of for example 1V to 20V.

In the exemplary embodiment depicted in FIG. 3 the shock waves are created in the corresponding manner, as has already been explained in conjunction with FIG. 2: In concrete terms shock waves S1 are guided by the shock wave generator element 210 essentially perpendicularly onto the surface 230 of the turbine vane 20 of the turbine blade 10. In addition the surface shock waves S2 are coupled directly with the surface shock wave generator element 220 into the turbine blade, which very rapidly removes the protective coating located there.

With the arrangement depicted in FIG. 3 the protective layer 40 can be removed completely from the turbine blade 10 in a cleaning time of appr. 20 minutes.

FIG. 4 shows a typical example of how the generator element 210 for generating the surface shock waves shown FIGS. 2 and 3 can be attached to the turbine blade 10. A piezo actuator 250 of the generator element 210 can be seen, which is attached to the foot 30 of the turbine blade 10 (e.g. glued on or welded on) and serves to couple the surface shock waves S2 directly into the turbine vane 20 such that the surface 230 of the turbine vane 20 oscillates perpendicular to the surface. This subjects the protective coating 40 to an impact effect perpendicular to the surface of the turbine vane 20, which facilitates removal of the protective coating 40; this is schematically indicated by an arrow P, which symbolizes the surface oscillations.

FIG. 5 shows an example of another position of the piezo actuator 250 on the turbine blade 10. In this exemplary embodiment the piezo actuator 250 is accommodated directly on the turbine vane 20. Such an arrangement of the piezo actuator 50 is basically also suited for speeding up the removal of the protective coating 40 from the turbine blade 10, because the surface shock waves S2 are coupled in directly into the surface 230 or vane surface of the turbine vane.

A slight disadvantage however is that a removal of the protective coating in the area of the attachment point 310 of the piezo actuator 250 is somewhat adversely affected under some circumstances, because the piezo actuator 250 can disrupt the effect of the electrolyte 300 on the attachment surface.

FIG. 6 shows an exemplary embodiment for the shock wave generator element 210 in accordance with FIGS. 2 and 3. A plurality of piezo actuators 400 can be seen which are arranged on a parabolic mounting surface 410. The arrangement of the piezo actuators 400 on the mounting surface 410 is selected in such cases so that a direction effect of the shock waves on the turbine blade 10 to be cleaned is achieved, as has been explained and depicted schematically in conjunction with FIGS. 2 and 3. The piezo actuators 400 each have piezoactive layers 420 which form the shock waves S1.

FIG. 7 shows a schematic diagram of the time gradient of the shock waves: The figure shows a preferably rectangular pressure characteristic with a peak pressure PO of between 10 and 500 MPa and a shock wave repetition frequency FS, which is produced in accordance with:

FS=2π/T

with T being the time interval between two consecutive individual impacts. The rise time of the impact edges F preferably amounts to less than 10 ns and the shock wave repetition frequency FS to less than 20 kHz.

To avoid damage to the turbine blade 10 by micro cracks for example shock wave impacts with a repetition frequency in the HZ range are preferably employed, with shock wave phases P1 being interrupted by shock-wave-free time intervals or idle phases P2.

1.-11. (canceled)

12. A method for removing a protective coating from a turbine blade, comprising:
introducing the turbine blade into a cleaning bath for chemical removal of the protective coating; and
producing mechanical shock waves into the cleaning bath during the chemical removal of the protective coating with a shock wave repetition frequency below 20 kHz.

13. The method as claimed in claim 12, further comprising directing the mechanical shock waves onto the turbine blade.

14. The method as claimed in claim 13, wherein the cleaning bath comprises an electrolyte and an electrical voltage is applied to the electrolyte.

15. The method as claimed in claim 14, wherein the shock waves are directed onto the outer side of the turbine blade by a shock wave generator element arranged spatially separated from the outer side of the turbine blade.

16. The method as claimed in claim 15, wherein the shock waves are focused on the outer side of the turbine blade.

17. The method as claimed in claim 16, wherein the shock waves are directed perpendicular to the turbine blade outer side.

18. The method as claimed in claim 17, wherein surface shock waves are fed into an outer side of the turbine blade with a generator element generating surface shock waves mechanically coupled to an outer side.

19. The method as claimed in claim 18, wherein the shock waves are directed perpendicularly onto the turbine vane of the turbine blade.

20. The method as claimed in claim 19, wherein surface shock waves are fed into the blade surface of the turbine blade with a generator element generating surface shock waves mechanically coupled to the blade surface.

21. An arrangement for removing a protective coating from a turbine blade, comprising:
a cleaning bath configured to accommodate immersion of the turbine blade for chemical removal of the protective coating; and
a shock wave generator that creates shock waves in the cleaning bath that aid in the removal of the protective coating from the turbine blade.

22. The arrangement according to claim 21, wherein the cleaning bath contains an electrolyte connected to a voltage source that creates an electrical voltage.

23. The arrangement according to claim 22, wherein the shock wave generator produces shock waves with a repetition frequency below 20 kHz.

24. The method as claimed in claim 23, wherein the shock wave generator is arranged spatially separated from an outer side of the turbine blade and directs the shock waves onto the outer side of the turbine blade.
